(19) United States
(12) Patent Application Publication
(10) Pub. No.: US 2002/0109937 A1
(43) Pub. Date: Aug. 15, 2002

(54) Mass data storage device having a motion sensor located on the actuator arm to make the sensor signal of minimum phase with respect to the actuator input signal

(75) Inventor: David P. Magee, Plano, TX (US)

Correspondence Address: TEXAS INSTRUMENTS INCORPORATED, P O BOX 655474, M/S 3999, DALLAS, TX, 75265

(73) Assignee: Texas Instruments, Inc.

(21) Appl. No.: 09/738,585

(22) Filed: Dec. 14, 2000

(51) Int. Cl. G11B 5/596

(52) U.S. Cl. 360/78.11; 360/78.12; 360/77.03

(57) ABSTRACT

A mass data storage device (10) and methods for making and using it are disclosed. The mass data storage device (10) has a read/write head (18) carried in proximity to one end of a selectively positionable arm (42), and an actuation device (20) in proximity to another end of the arm for moving the arm in response to an input signal (31). The mass data storage device (10) has a sensor, such as an accelerometer (38), or the like, carried on the arm (42) for generating a motion signal for use in position control of the arm (42). The sensor (38) is located on the arm (42) at a location at which the motion signal (39) and the actuator input signal (31) have a minimum phase difference. The signal (39) from the sensor (38) may be fed back to control the actuation device (20), and may include a filter (60) that shapes the motion signal to equalize any resonances in the arm or rejects torque effects of the arm (42).

### BACKGROUND OF THE INVENTION

1. Field of the Invention

This invention relates to improvements in methods and apparatuses for dynamic information storage or retrieval, and more particularly to improvements in methods, hardware, and circuitry for improving the accuracy in positioning a read/write head in a mass data storage device, or the like, and to improvements in methods, hardware, and circuitry that enable the track density of the data media to be increased.

2. Relevant Background

Mass data storage devices include well known hard disk drives that have one or more spinning magnetic disks or platters onto which data is recorded for storage and subsequent retrieval. Hard disk drives may be used in many applications, including personal computers, set top boxes, video and television applications, audio applications, or some mix thereof. Many applications are still being developed. Applications for hard disk drives are increasing in number, and are expected to further increase in the future. Mass data storage devices may also include optical disks in which the optical properties of a spinning disk are locally varied to provide a reflectivity gradient that can be detected by a laser transducer head, or the like. Optical disks may be used, for example, to contain data, music, or other information.

In modern computers and computer-type applications, one or more mass data storage devices may be employed. Typical mass data storage devices, often referred to as hard disk drives, CD-ROMs, or the like, have one or more rotating data storage disks. The data storage disks may have thereon, for example, a magnetic, optical, or other media that can contain data. In such devices, data is generally recorded in certain field portions of rings or tracks that are physically located radially with respect to the center of the disk.

The term “data” is used herein generally to mean data of all kinds, including servo data, such as Gray code information, AGC signals, head alignment bursts, and the like, recorded in servo sectors, and including user data, recorded in user data sectors.

However, there has been considerable recent pressure on disk drive manufacturers to increase the density of the data written to a disk to increase the capacity of the drive. Much effort has been directed to data detection techniques to increase the density of the data that can be contained on the disk. In general, track density of a hard disk drive is related to the bandwidth of the position control system for the read/write head. However, capabilities of the control system to reject physical disturbances also play an important part in the tracking performance of the system. Resonances associated with the arm that carries and moves the read/write head, herein called the “load beam”, limit the bandwidth of the control system, and therefore limit the achievable track density. Since the position sensing system in a HDD is noncollocated, the resonances appear as nonminimum phase dynamics that tend to destabilize the control system.

As used herein, the terms “collocated” and “noncollocated” refer to the relative location between the input to the system and the output from the system. More particularly, efforts have been directed recently to providing acceleration feedback for resonance equalization. In some proposed HDD environments, an accelerometer is placed between the input, which is the voice control motor (VCM) that provides a torque to one end of the load beam, and the output, which is the read/write head located at the other end of the load beam. When the actuation point and the accelerometer are not the same point, as has been done in the past, the system is referred to as “noncollocated”. In such a system, if there is relative motion between the input point and the acceleration measurement point, the system is modeled as a compliant body. Resonances of the system, therefore, become an issue. Also, the relative phase between the input and the accelerometer becomes an issue.

If the actuator and sensor are located at the same point, they are referred to as “collocated.” In a collocated system, some states of the system can be controlled exactly. However, this configuration is usually physically unrealizable. Thus, the compromise usually used is to place the sensor and actuator as close as possible. This configuration is still referred to as “collocated” as long as the dynamics of the system (the load beam in the HDD example) between the input and output points can be approximated as a rigid body, i.e., there is no relative motion between the two points.

Efforts to use acceleration feedback for resonance equalization, however, have been very limited. This is primarily because the system dynamics have been modeled incorrectly or because the accelerometer has been placed in a poor location for providing a minimum phase signal. Accelerometer feedback has been used successfully in laboratory experiments, but typically, the accelerometer was placed at a location where the resulting signal was of nonminimum phase. This can be determined, for instance, from the phase response of the transfer function representing the input/output relationship. If there is a net phase loss of 180° adjacent to a particular resonance peak, then the resonance is considered nonminimum phase. (If there is no net phase loss near the resonant frequency, then the resonance is considered to be minimum phase.)

Some researchers have proposed to use a collocated or nearly collocated position sensor as feedback to provide damping control of resonances. However, it has been determined that an acceleration measurement, not a position measurement, is ideal for collocated feedback.

Other investigators have incorporated an accelerometer into their solution. However, they located the accelerometer on the HDD housing. Thus, the sensor was not collocated with the actuation system. Furthermore, their system was designed to minimize the vibration generated by an active head positioner on the head positioners that are not currently active. That is, their compensation strategy was not for the active head positioning system.

What is needed is an acceleration control method and system that provides a higher bandwidth solution than existing architectures, which provides better disturbance rejection properties and thus achieves higher track densities.

### SUMMARY OF THE INVENTION

In light of the above, it is, therefore an object of the invention to provide an improved feedback technique using an acceleration measurement for positioning a data sensor carrying arm in a mass data storage device, or the like.

It is another object of the invention to provide an improved feedback technique using an acceleration measurement, which permits a higher control system bandwidth than current architectures, provides better disturbance rejection properties, and thus can achieve higher track densities in a mass data storage device system, or the like.

One of the advantages of the invention is that it enables an acceleration feedback signal to be incorporated into a conventional control system so that the overall bandwidth of the control system can be increased. As a result, higher track densities can be achieved in conventional hard disk drive architectures.

Another advantage of the invention is that it enables a load beam motion sensor to be located on the load beam without particular regard to whether or not the position of the sensor is collocated with the actuator input.

The invention has several features. The first feature recognizes the importance of sensor location on the performance of the control system for the mass data storage device. By locating a sensor in a region where the resonant dynamics to be eliminated are observable in the output signal from the sensor and are minimum phase with respect to the actuator input signal, the feedback design can provide better performance than existing systems. The invention also provides a control architecture for incorporating an acceleration sensor into the system. The sensor output is shaped by a filter to provide the best disturbance rejection performance. Finally, mathematically the acceleration feedback solution looks like a notch filter solution in the overall open loop transfer function, but the internal dynamics of the acceleration feedback configuration provide better torque disturbance rejection than can be achieved with just a notch filter.

Thus, in accordance with a broad aspect of the invention, a mass data storage device is presented which has a read/write head carried in proximity to one end of an actuator arm and a an actuation device in proximity to the other end of the arm for moving the arm in response to an actuator input signal. The device has a sensor, such as an accelerometer, strain gauge, or the like, carried on the arm for generating a motion signal for use in position control of the arm. The sensor is located on the arm at a location at which the motion signal and the actuator input signal have a minimum phase difference. The signal from the sensor may be fed back to control the actuation device, and may include a filter that shapes the motion signal to assist the control system in equalizing any resonances in the arm and rejecting any torque disturbances.

According to another broad aspect of the invention, a method for constructing a mass data storage device is presented. The method includes attaching a read/write head in proximity to one end of a selectively positionable arm, and attaching the selectively positionable arm to an actuation device for selectively positioning the arm. The actuation device may be controlled by an actuator input signal. A location is determined on the arm at which a motion response of the arm to the actuator input signal has a minimum phase difference with respect to the actuator input signal. A sensor, such as an accelerometer, or the like, is located on the arm at the determined location that provides a minimum phase motion signal for controlling a position of the arm.

According to still another broad aspect of the invention, a method is presented for constructing a mass data storage device having an arm which carries a read/write head adjacent to one end of the arm and which is positionable by an actuation mechanism adjacent to another end of the arm. The method includes attaching a sensor, such as an accelerometer, or the like, to the arm at the location at which a motion response of the arm and the input signal for operating the actuation mechanism have a minimum phase difference. A signal is then fed back from the sensor to the actuator input signal to control a position of the arm.

According to yet another broad aspect of the invention, a method is presented for locating a motion sensor on a selectively positionable arm of a mass data storage device. The method includes sensing a motion of the arm from a location on the arm at which a motion response of the arm and an actuator input signal for positioning the arm have a minimum phase difference, and feeding back a signal representing the sensed motion to the actuator input signal to control the position of the arm.

### BRIEF DESCRIPTION OF THE DRAWINGS

The invention is illustrated in the accompanying drawings, in which:

FIG. 1 is a block diagram of a generic disk drive system, illustrating the general environment in which the invention may be practiced, showing a location of an accelerometer near the base of the load beam of the drive, so that its output signal contains the resonant dynamics that are to be eliminated, and so that the output signal is minimum phase with respect to the actuator input signal, according to a preferred embodiment of the invention.

FIG. 2 shows a Matlab® (“MATLAB” is a registered trademark of MathWorks, Inc. of Natick, Mass.) simulation of a standard control system for an disk drive system of FIG. 1, having an acceleration feedback configuration to eliminate the resonant dynamics associated with the load beam, according to a preferred embodiment of the invention.

FIG. 3 shows graphs of magnitude and phase vs. frequency for the simulation of FIG. 2, comparing the open loop frequency response of a baseline control system design without resonance compensation to a notch filter control system design and an acceleration feedback control system design, according to a preferred embodiment of the invention.

FIG. 4 shows graphs of track error and magnitude vs. frequency for a tracking response for the simulation of FIG. 2 of the three control systems with base motion, torque, runout, and demodulation disturbances for 200 msec, according to a preferred embodiment of the invention.

FIG. 5 shows graphs of the voltage signals for the simulation of FIG. 2 from the baseline, the notch filter, and the acceleration feedback simulations for 200 msec, according to a preferred embodiment of the invention.

FIG. 6 shows graphs of magnitude vs. frequency of a voltage power spectrum for the simulation of FIG. 2 for the baseline, the notch filter, and the acceleration feedback designs, according to a preferred embodiment of the invention.

FIG. 7 shows graphs of magnitude vs. frequency for the simulation of FIG. 2 of the magnitude response of the base motion disturbance rejection for the baseline, the notch filter, and the acceleration feedback designs, according to a preferred embodiment of the invention.

FIG. 8 shows graphs of magnitude vs. frequency for the simulation of FIG. 2 of the magnitude response of the torque disturbance rejection for the baseline, the notch filter, and the acceleration feedback designs, according to a preferred embodiment of the invention.

FIG. 9 shows graphs of magnitude vs. frequency for the simulation of FIG. 2 of the magnitude response of the runout disturbance rejection for the baseline, the notch filter, and the acceleration feedback designs.

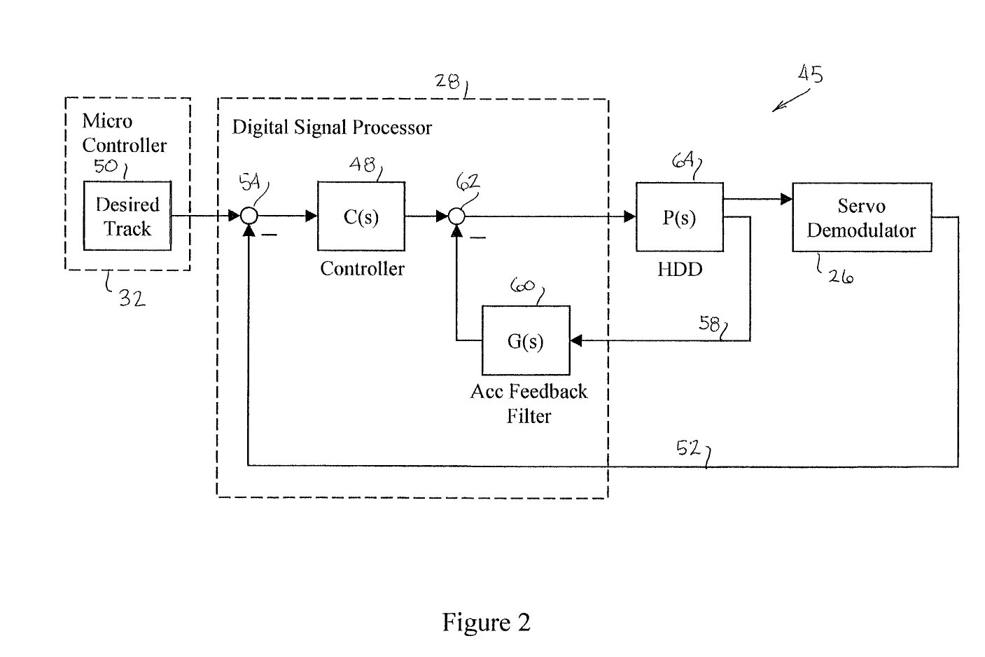

And FIG. 10 shows graphs of magnitude vs. frequency for the simulation of FIG. 2 of the magnitude response of the demodulation disturbance rejection for the baseline, the notch filter, and the acceleration feedback designs.

In the various figures of the drawing, like reference numerals are used to denote like or similar parts.

### DETAILED DESCRIPTION OF THE PREFERRED EMBODIMENTS

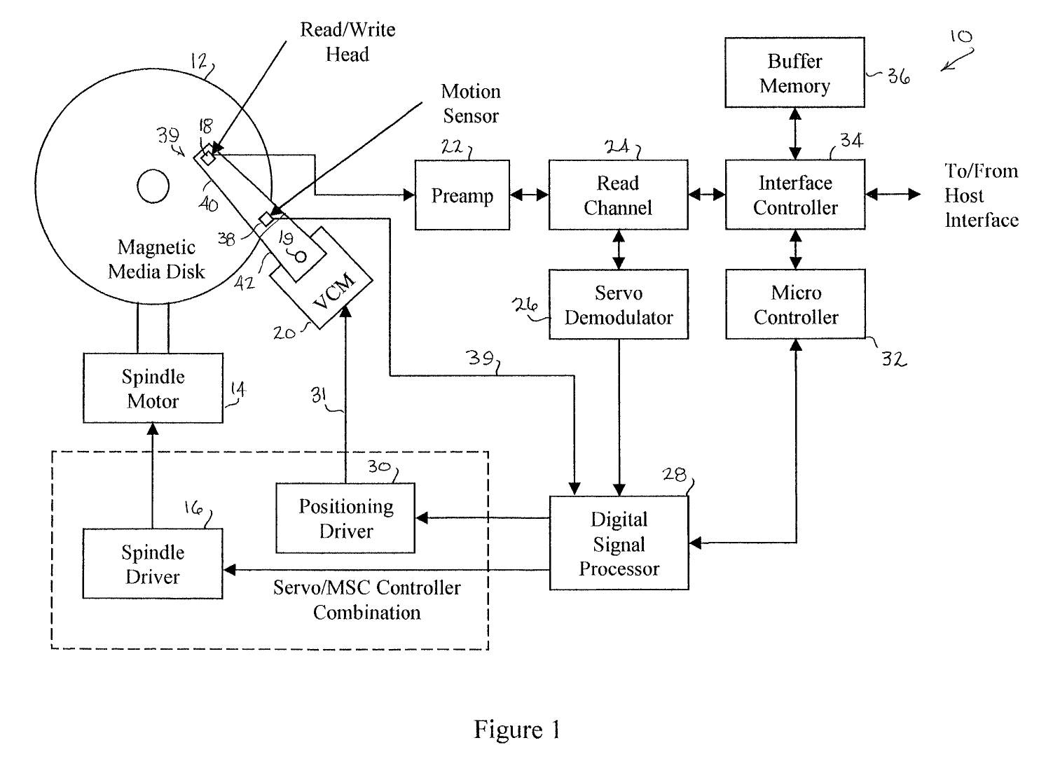

According to a preferred embodiment of the invention, an accelerometer is incorporated into the feedback path of a data sensor arm actuation system, with a compensation strategy that reduces vibration of a mass data storage device, in general, and a hard disk drive (HDD), in particular. This is illustrated in the block diagram of a generic disk drive system 10 shown in FIG. 1. The disk drive system 10 of FIG. 1 illustrates one generalized environment in which the invention may be practiced.

The system 10 includes a magnetic media disk 12 that is rotated by a spindle motor 14 controlled by a spindle driver circuit 16. A data transducer or head 18 is carried on an arm 39, which can be selectively rotated about a pivot point 19 of the shaft of the voice coil motor 20 to locate the head 18 in proximity to selectable radial tracks (not shown) of the disk 12. The radial tracks may contain magnetic states that contain information about the tracks, such as track identification data, location information, synchronization data, user data, and so forth. The arm 39 has an “E-block” portion 42 mounted to the shaft of the voice control motor 20 and a load beam portion 40 that carries the head 18 in proximity to the disk 12.

In a magnetic media hard disk drive of the type illustrated, the head 18 may be used both to record user data to and read user data back from the disk 12, as well as to detect signals that identify the tracks and sectors at which data is written, and to detect servo bursts that enable the head 18 to be properly aligned with the tracks of the disk 12. The head 18 is hereafter referred to as a “read/write” head; however, it should be understood that use of the invention is not intended to be limited to systems that provide capabilities for both reading and writing data. Also, it should be noted that the invention is not intended to be limited to magnetic systems, and can be equally advantageously used in conjunction with other systems, such as optical systems, or the like.

In the context of the magnetic hard disk drive system shown, a preamplifier 22 amplifies analog electrical signals that are generated by the read/write head 18 in response to the magnetic signals recorded on the disk 12 for delivery to read channel circuitry 24. Servo signals are detected and demodulated by one or more servo demodulator circuits 26 and processed by a digital signal processor (DSP) 28 to control the position of the head 18 via signals 31 from the positioning driver circuit 30.

A microcontroller 32 is typically provided to control the DSP 28, as well as an interface controller 34 to enable data to be passed to and from a host interface (not shown), in known manner. A data memory 36 may be provided, if desired, to buffer data being written to and read from the disk 12.

According to a preferred embodiment of the invention, a sensor, such as an accelerometer 38 shown, a strain gauge, or the like, is placed on the load beam 40 to provide motion signals 39 for feedback to control the VCM 20. Preferably, the accelerometer that is incorporated into the system is a small piezoelectric-type accelerometer. Piezoelectric-type accelerometers have frequency ranges from 0.7 to 20,000 Hz, so sensor bandwidth with such accelerometer types should not be an issue. In the embodiment shown, the accelerometer 38 is positioned on the load beam 40 such that its response to the input signal to the VCM 20 is of minimum phase.

The location where a minimum phase difference exists can be determined experimentally by placing the accelerometer on the load beam 40 and measuring the resulting frequency response. For example, a sinusoidal signal of known amplitude and frequency may be added to the control command supplied by the positioning driver 30, and the resulting acceleration response generated by the accelerometer measured. After taking into consideration the closed loop nature of the measurement, the relative magnitude and phase of the acceleration response with respect to the input sinusoid yields one point on the frequency response. The measurements may then be repeated over a desired frequency range. If a peak appears in the magnitude response, then it is known that the accelerometer is located at a resonance point. If the phase response near the resonant frequency is not minimum phase, then the accelerometer must be relocated and the frequency response measurement process repeated. On the other hand, if the phase response is minimum phase, then a good accelerometer location has been found.

HDD companies, of course, have finite element models of their systems so a starting location for the accelerometer can be determined relatively quickly. Basically, transfer functions can be formed between the input point and the output point, and then the poles and zeros of the transfer function determined. If the zeros for a resonance are in the left half plane of the complex s-domain, then the resonance is minimum phase. This is another attribute of minimum phase resonances.

After properly locating the accelerometer as described above, feedback techniques are enabled that circumvent prior limitations on the bandwidth of the control system and disturbance rejection properties. Thus, with the accelerometer positioned as described, a higher bandwidth control system can be achieved. Furthermore, better disturbance rejection properties than currently used architectures can be provided, which can reduce the effect of torque disturbances on the system.

As mentioned above, one location for the accelerometer 38 may be near the base of the load beam 40. The load beam 40 is the most compliant member in this positioning system, so locating the accelerometer near the end of the load beam near the E-block is preferable. The goal is to locate the accelerometer so that its output signal contains the resonant dynamics that are to be eliminated, and so that the output signal is of minimum phase with respect to the actuator input. One desirable location is where the particular mode of vibration to be canceled is most observable in the output signal, while maintaining the minimum phase requirement. Therefore, a node point for a particular mode of vibration would be a poor choice.

Once this region has been located, a feedback system may be used to eliminate the resonant dynamics associated with the load beam. One feedback system 45 that can be used is shown in FIG. 2, to which reference is now additionally made. The system 45 shows a standard control system, C(s), 48, which may be a programmed portion of the digital signal processor 28. The system 45 has been simulated in a Matlab® simulation, described below to demonstrate the characteristics that result from the placement of the accelerometer, as above described. The input to the controller 48 is a signal representing the difference between the desired track 50 and the current track 52, indicated by the servo demodulator 26. The difference is developed by a summer 54. A shaft acceleration signal 58 is generated to provide a minimum phase acceleration signal, that was used in this simulation, which is passed through an acceleration feedback filter, G(s), 60 and subtracted by a summer 62 from the convention control signal to give the input to the HDD 64. The shaft acceleration signal 58 was used in the Matlab® simulation described below.

The acceleration feedback filter designed to cancel one mode of vibration is of the form

$$G ( s ) = \frac{[ \begin{matrix}2 ( {ζ}_{d1} {ω}_{d1} - {ζ}_{p1} {ω}_{p1} ) {s}^{3} + [ 2 ( {ζ}_{d1} {ω}_{d1} - {ζ}_{p1} {ω}_{p1} ) {K}_{e} + \\ {ω}_{d1}^{2} - {ω}_{p1}^{2} ] {s}^{2} + [ 2 ( {ζ}_{d1} {ω}_{d1} - {ζ}_{z1} {ω}_{z1} ) {K}_{m} + {ω}_{d1}^{2} - \\ {ω}_{p1}^{2} ] {K}_{e} s + ( {ω}_{d1}^{2} - {ω}_{z1}^{2} ) {K}_{m} {K}_{e}\end{matrix} ]}{{K}_{d} s ( {s}^{2} + 2 {ζ}_{z1} {ω}_{z1} s + {w}_{z1}^{2} )} \qquad ( 1 )$$

where all of the parameters are related to the characteristics of the plant. This filter is realizable in a discrete-time control system because the transfer function is proper, minimum phase and stable.

By filtering the acceleration with this filter, the effective transfer function of the HDD system becomes

$${P}_{2} ( s ) \approx \frac{{K}_{d} {R}_{nc1}^{n} {R}_{nc2}^{n}}{s [ s ( s + {K}_{e} ) + {K}_{e} {K}_{m} ] {F}_{1}^{d} {R}_{c2}^{n}} \qquad ( 2 )$$

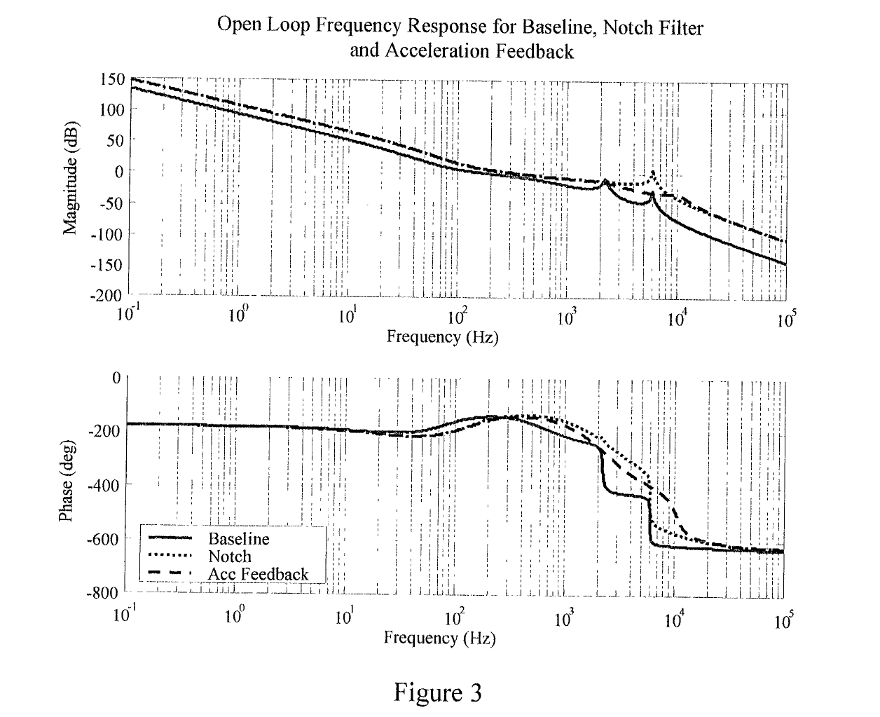

which is just a VCM in series with two resonances. However, the poles dynamics for the first resonance are well damped so that peaking does not occur in the frequency response. This can be seen from the graphs of FIG. 3, to which reference is now additionally made. In FIG. 3 the open loop frequency response of a baseline control system design without any resonance compensation is compared to a notch filter control system design and an acceleration feedback control system design. It can be seen that the notch filter design and the acceleration feedback design have a higher open loop bandwidth for a given gain and phase margin. This is because they compensate for the first resonance in the system. Even though the acceleration feedback solution was designed to cancel only the first resonance, it is also able to dampen the effect of the second resonance, unlike the notch filter solution.

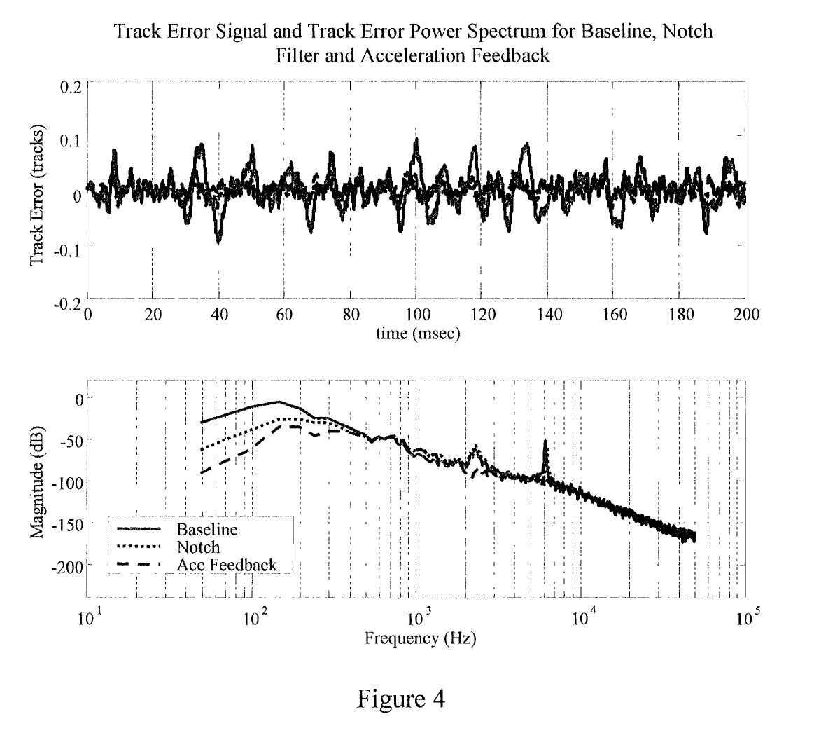

FIG. 4, to which reference is now additionally made, shows the simulated tracking response of the three control systems with base motion, torque, runout and demodulation disturbances for 200 msec. The three standard deviation calculation of the track error signal has been reduced from 0.1 to 0.045 with the notch filter solution. This reduction corresponds to a 55% improvement in tracking performance over the baseline control system. Furthermore, the three standard deviation calculation of the track error signal has been reduced from 0.1 to 0.03 with the acceleration feedback solution. This reduction corresponds to a 70% improvement in tracking performance over the baseline control system.

FIG. 4 also shows the power spectrum of the track error signal when using the baseline control system, the notch filter control system and the acceleration feedback control system. For the notch filter design, the track error signal still contains several dominant sinusoidal components. Although a scheme was not designed to minimize repeatable runout, more bandwidth allows the notch filter to further suppress this disturbance. As a result, the peak near 120 Hz has been distributed over a range of frequencies from 120 Hz to 300 Hz with less amplitude. The other two peaks at 2.2 kHz and 6 kHz correspond to the resonance frequencies of the load beam and cannot be prevented with the notch filter design. So even though the notch filter was designed to cancel the first resonant frequency, it really cannot prevent its excitation because of the disturbances that exist in the system.

For the acceleration feedback design, the track error signal does not really contain any distinct sinusoidal components. A peak corresponding to repeatable runout is no longer recognizable at a particular frequency in the power spectrum. Rather, the energy has been distributed over a range of frequencies from 100 Hz to 800 Hz with less amplitude than the notch filter design. The acceleration feedback design also equalizes the resonances in the track error response so there is no peaking at 2.2 kHz and 6 kHz in the power spectrum. This characteristic allows the acceleration feedback design to provide better tracking performance.

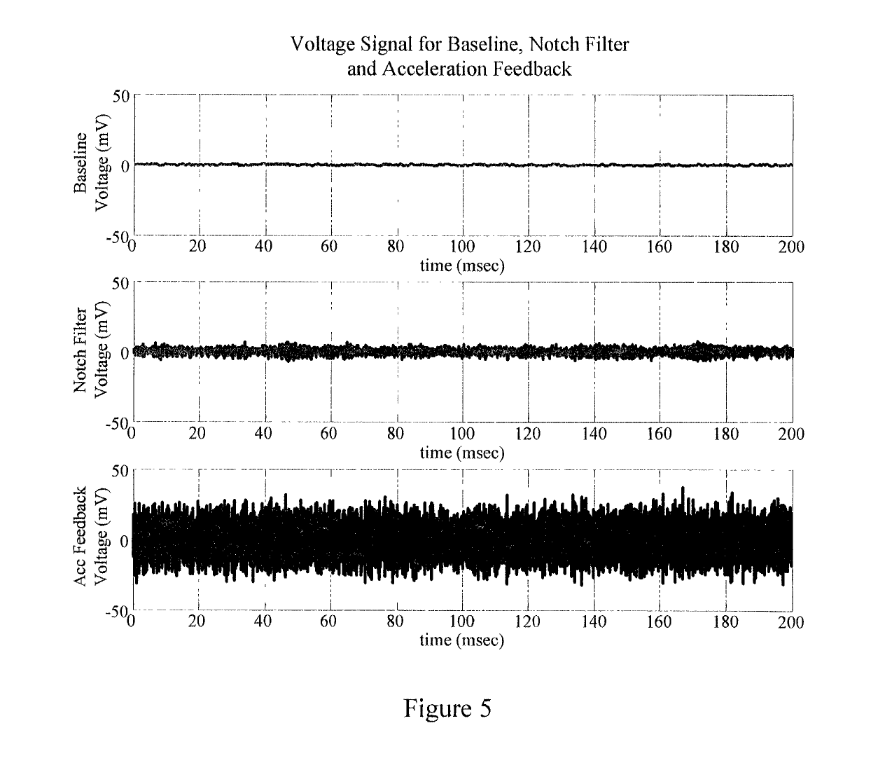

The voltages required for these designs are also of interest because the HDD system has a limited power supply. FIG. 5, to which reference is now additionally made, shows a plot of the voltage signals from the baseline, the notch filter, and the acceleration feedback simulations for 200 msec. For the baseline design, the maximum voltage level is only 1.13 mV. For the notch filter design, the maximum voltage level is 7.65 mV and for the acceleration feedback design, the maximum voltage level is 37.3 mV. All of which are within acceptable limits.

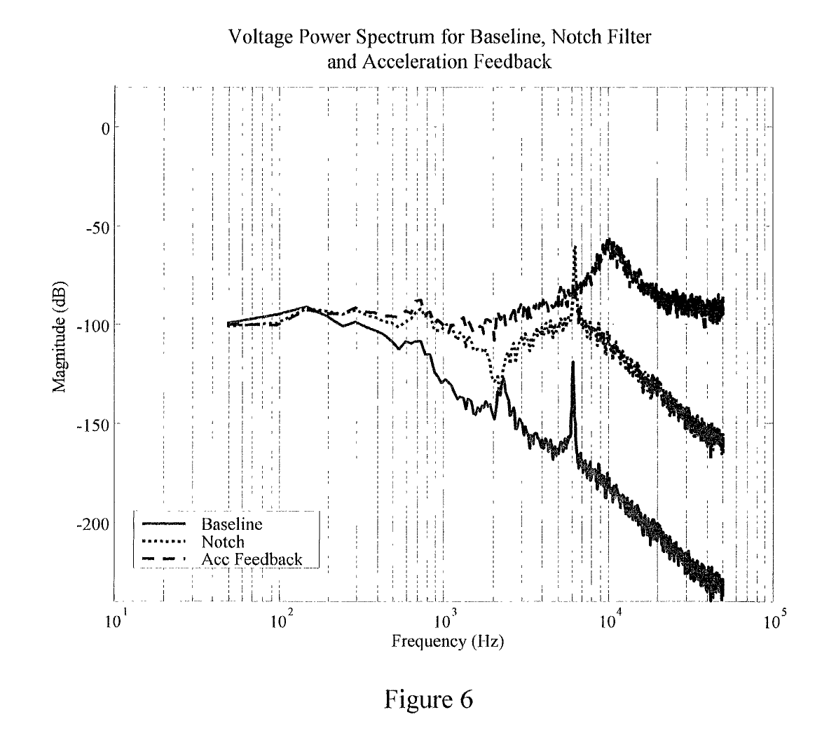

FIG. 6, to which reference is now additionally made, shows the voltage power spectrum for the baseline, the notch filter and the acceleration feedback designs. For the baseline design, peaks are present in the voltage power spectrum at both resonant frequencies of the load beam. However, the notch filter has equalized the first resonance so there is a notch in the power spectrum at the first resonant frequency. Since the filter was only designed to equalize the first resonance, the power spectrum does contain a peak at the second resonant frequency. For the acceleration feedback design, both resonant frequencies have been equalized so there is no peaking at 2.2 kHz or 6 kHz in the power spectrum. However, a peak near 10 kHz has materialized in the voltage power spectrum, which is a result of the small peak at the same frequency in the open loop frequency response shown in FIG. 3. This peak passes sinusoidal components near 10 kHz, which allows the voltage signal in FIG. 6 to contain high frequency oscillations.

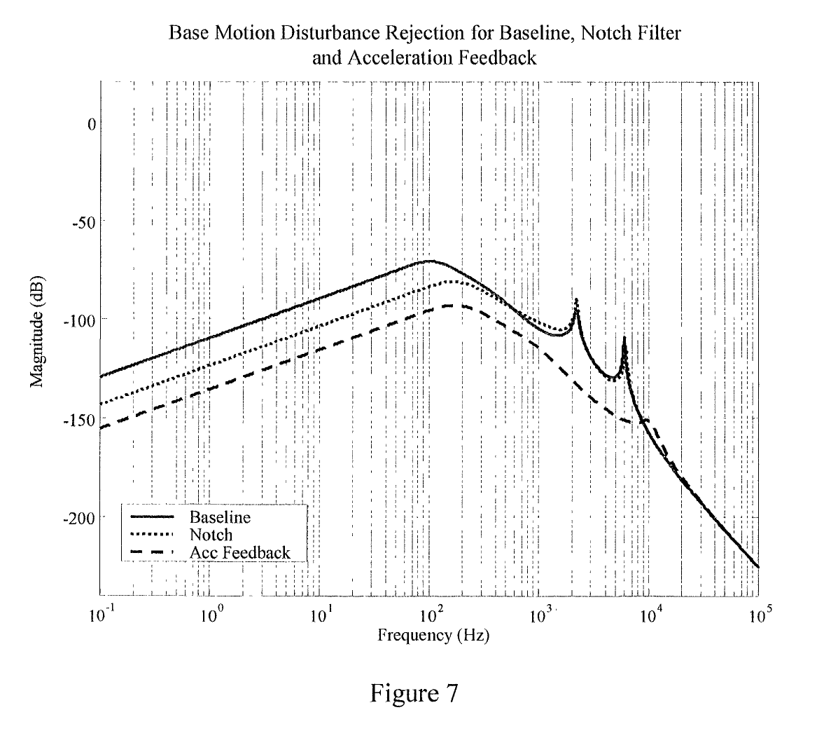

The improved tracking performance from the notch filter and acceleration feedback designs can be explained by comparing their disturbance rejection curves. FIG. 7, to which reference is now additionally made, shows the magnitude response of the base motion disturbance rejection for the baseline, the notch filter and the acceleration feedback designs. At frequencies below 100 Hz, the notch filter design provides about 14 dB more rejection than the baseline design. However, the notch filter design does not provide any better rejection the baseline design at the resonant frequencies. With either design, base motion disturbances can easily excite the resonant dynamics of the load beam.

The acceleration feedback design, on the other hand, provides 25 dB more rejection than the baseline design at frequencies below 100 Hz. At the resonant frequencies, the rejection increases to nearly 42 dB. As a result, the acceleration feedback design does not allow base motion disturbances to excite the resonant dynamics of the load beam. However, the disturbance rejection curve does have some slight peaking near 10 kHz as a result of the peaking in the open loop frequency response.

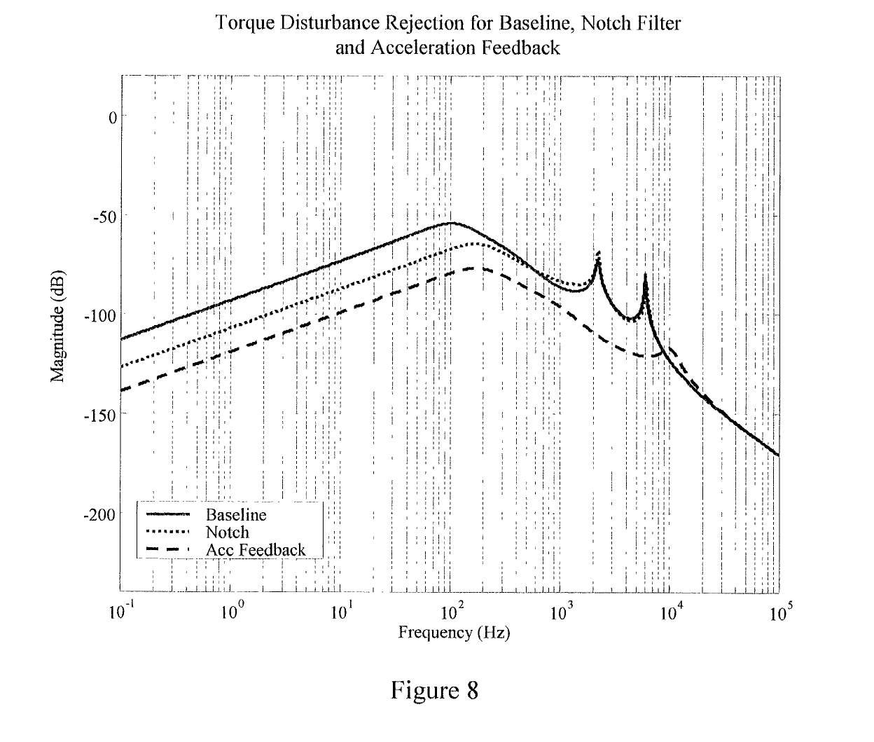

FIG. 8, to which reference is now additionally made, shows the magnitude response of the torque disturbance rejection for the baseline, the notch filter and the acceleration feedback designs. It can be seen that the torque disturbance rejection curve is very similar to the base motion disturbance rejection curve. At frequencies below 100 Hz, the notch filter design provides about 14 dB more rejection than the baseline design. However, the notch filter design does not provide any better rejection than the baseline design at the resonant frequencies. With either design, torque disturbances can easily excite the resonant dynamics of the load beam.

The acceleration feedback design, on the other hand, provides 25 dB more rejection than the baseline design at frequencies below 100 Hz. At the resonant frequencies, the rejection increases to nearly 42 dB. As a result, the acceleration feedback design does not allow torque disturbances to excite the resonant dynamics of the load beam. However, the disturbance rejection curve does have some slight peaking near 10 kHz as a result of the peaking in the open loop frequency response.

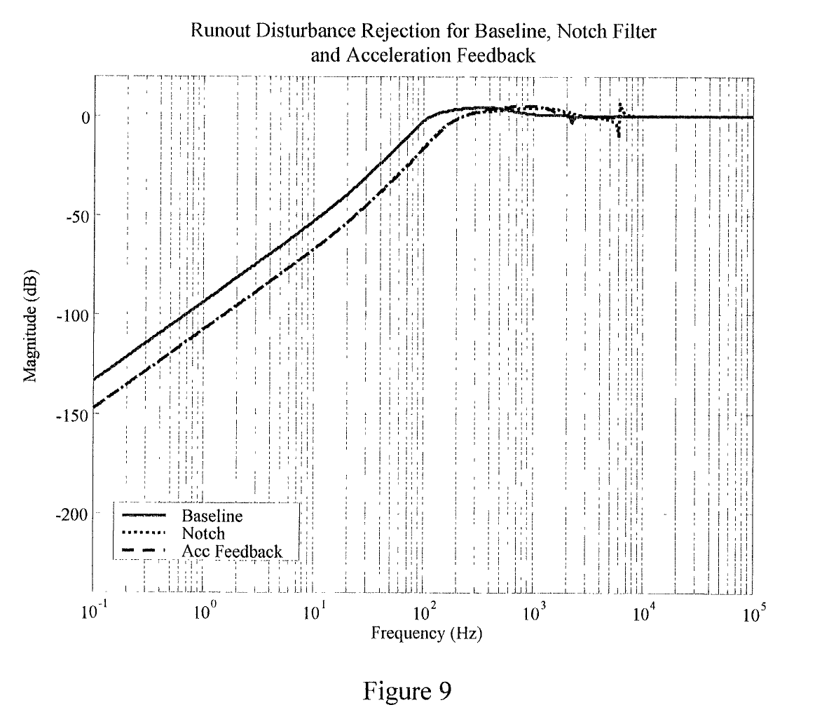

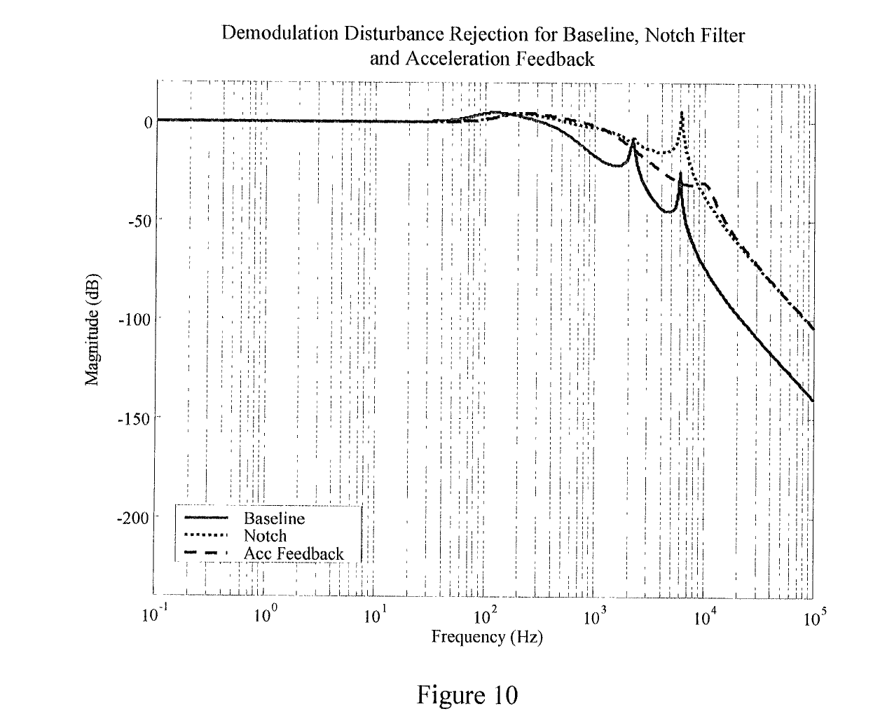

FIG. 9, to which reference is now additionally made, shows the magnitude response of the runout disturbance rejection for the baseline, the notch filter and the acceleration feedback designs. At frequencies below 100 Hz, the notch filter and the acceleration feedback designs provide about 14 dB more rejection than the baseline design. However, at frequencies above 100 Hz, the disturbance rejection curves all converge to the same value: one (0 dB). This behavior means that the open loop crossover frequency limits the range of disturbance rejection for each design. It also means that the control system will command the read/write head to follow the high frequency runout disturbances exactly, which can degrade HDD tracking performance.

FIG. 10, to which reference is now additionally made, shows the magnitude response of the demodulation disturbance rejection for the baseline, the notch filter and the acceleration feedback designs. Since this response complements the runout disturbance rejection response, all of the curves have the same low frequency value: one (0 dB). Unlike the baseline design, the notch filter design can prevent demodulation disturbances from exciting the first resonance of the load beam. However, the acceleration feedback design is able to prevent demodulation disturbances from exciting either resonance of the load beam even though it was designed to only equalize the first one.

The notch filter and the acceleration feedback designs also have less rejection at high frequency, about 37 dB, than the baseline design. Since this frequency response is identical to the closed loop response of the system, the control system for these designs will command the read/write head to follow low frequency demodulation disturbances. Therefore, the demodulation of the embedded servo patterns should occur with very little uncertainty in the position measurement.

From these figures, it is clear that the acceleration feedback solution provides superior disturbance rejection to a standard notch filter solution that exists in disk drives today. These improvements translate into better tracking performance for the drive, which will permit higher TPIs in hard disk drives.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A mass data storage device having a read/write head carried in proximity to one end of a selectively positionable arm, and an actuation device in proximity to another end of said arm for moving said arm in response to an actuator input signal, comprising:
a sensor carried on said arm for generating a motion signal for use in position control of said arm, located on said arm at a location at which said motion signal and said actuator input signal have a minimum phase difference.

2. The mass data storage device of claim 1 wherein said sensor is an accelerometer, and said motion signal is an accelerometer signal.

3. The mass data storage device of claim 2 wherein said accelerometer is a piezoelectric-type accelerometer.

4. The mass data storage device of claim 1 wherein said sensor is an strain gauge.

5. The mass data storage device of claim 1 further comprising a feedback circuit between said sensor and said actuation device incorporating said minimum phase acceleration signal.

6. The mass data storage device of claim 1 further comprising a feedback circuit between said sensor and said actuation device, said feedback circuit including a filter that shapes the motion signal to equalize any resonances in said arm.

7. The mass data storage device of claim 5 wherein said filter enables the rejection of torque disturbances of said arm.

8. The mass data storage device of claim 1 wherein said mass data storage device is a hard disk drive.

9. A method for constructing a mass data storage device, comprising:
attaching a read/write head in proximity to one end of a selectively positionable arm;
attaching said selectively positionable arm to an actuation device for selectively positioning said arm;
applying an actuator input signal to said actuation device;
determining a location on said arm at which a motion response of said arm to said actuator input signal has a minimum phase difference with respect to said actuator input signal;
and locating a sensor to said arm at said location for providing an arm motion signal for use in controlling a position of said arm.

10. The method of claim 9 wherein said locating a sensor comprises locating an accelerometer.

11. The method of claim 9 wherein said locating a sensor comprises locating a strain gauge.

12. The method of claim 9 wherein said locating a sensor comprises locating a piezoelectric-type accelerometer.

13. The method of claim 9 further comprising providing a feedback circuit between said sensor and said actuation device incorporating said minimum phase difference.

14. The method of claim 9 further comprising providing a filter in said feedback circuit to shape the motion signal to equalize any resonances in said arm.

15. The method of claim 9 further providing a filter in said feedback circuit that enables the rejection of torque disturbances of said arm.

16. A method for constructing a mass data storage device having an arm which carries a read/write head adjacent one end of said arm and which is positionable by an actuation mechanism adjacent another end of said arm, comprising:
attaching a sensor to said arm at said location at which a motion response of said arm and an actuator input signal for operating said actuation mechanism have a minimum phase difference; and
feeding back a signal from said sensor to said actuator input signal to control a position of said arm.

17. The method of claim 16 wherein said locating a sensor comprises locating an accelerometer.

18. The method of claim 16 wherein said locating a sensor comprises locating a piezoelectric-type accelerometer.

19. The method of claim 16 wherein said locating a sensor comprises locating a strain gauge.

20. The method of claim 16 further wherein said feeding back a signal further comprises equalizing any resonances in said arm.

21. The method of claim 20 further wherein said equalizing comprises filtering resonances in said arm.

22. The method of claim 16 wherein said feedback signal further enables the rejection of torque disturbances of said arm.

23. A method for positioning a read/write head on an selectively positionable arm of a mass data storage device, comprising:
sensing a motion of said arm from a location on said arm at which a motion response of said arm and an actuator input signal for positioning said arm have a minimum phase difference; and
feeding back a signal representing said sensed motion to said actuator input signal to control said positioning said arm.

24. The method of claim 23 wherein said sensing a motion comprises developing an acceleration signal.

25. The method of claim 23 further comprising filtering said feedback signal to equalize resonances in said arm.

26. The method of claim 23 further comprising filtering said feedback signal to reject torque disturbances of said arm.
